(19) United States
(12) Patent Application Publication
(10) Pub. No.: US 2014/0025457 A1
(43) Pub. Date: Jan. 23, 2014

(54) METHOD AND SYSTEM FOR DEAL REDEMPTION BY ELECTRONIC WALLET

(71) Applicants: Jose-Luis Celorio MARTINEZ, New York, NY (US); Andrea Christine GILMAN, Chappaqua, NY (US)

(72) Inventors: Jose-Luis Celorio MARTINEZ, New York, NY (US); Andrea Christine GILMAN, Chappaqua, NY (US)

(73) Assignee: MASTERCARD INTERNATIONAL INCORPORATED, Purchase, NY (US)

(21) Appl. No.: 13/551,124

(22) Filed: Jul. 17, 2012

(51) Int. Cl. G06Q 20/36; G06Q 20/40; G06Q 30/02

(52) U.S. Cl. 705/14.23

(57) ABSTRACT

A method for initiating a financial transaction on a mobile device includes: transmitting, by a transmitter, a wallet identifier associated with the mobile device; receiving, by a receiver, transaction information for a financial transaction to be initiated, wherein the transaction information includes at least a transaction amount; storing, in a database, at least one deal and a payment card, wherein each deal of the at least one deal includes at least a discount amount; receiving, via an input, an indication of a deal of the at least one deal to be applied to the financial transaction to be initiated; and initiating, by a processor, a financial transaction by transmitting an authorization request for the financial transaction, wherein the authorization request includes the payment card and is for a remaining amount, the remaining amount based on the transaction amount and the discount amount corresponding to the indicated deal.

### FIELD

The present disclosure relates to the redemption of daily deals using an electronic wallet, specifically the selection of a deal and payment card to be applied to a transaction on a mobile device and then the initiation of the financial transaction by that mobile device or a merchant point-of-sale.

### BACKGROUND

Many consumers have begun to utilize electronic wallets as a more secure and more convenient method for paying for in-person financial transactions with merchants. At the same time, many consumers have also begun to use deals (e.g., coupons, discounts, offers, etc.). However, the deals that consumers wish to use at a merchant often come in a physical form. The deal is presented to the merchant, who then must verify the validity of the deal and apply it to the transaction using their existing point-of-sale technology. This process can be time consuming for the merchant, and is also inefficient for the consumer who must maintain both the physical deal as well as the electronic wallet.

Thus, there is a need for a mobile device that uses an electronic wallet to store both deal and payment information that can initiate the financial transaction based on transaction details provided by the merchant without the need for additional verification and the use of physical media.

### SUMMARY

The present disclosure provides a description of a systems and methods for redemption of a deal using an electronic wallet by initiating a financial transaction on a mobile device or a merchant point-of-sale.

A method for initiating a financial transaction on a mobile device includes: transmitting, by a transmitter of the mobile device, a wallet identifier associated with the mobile device; receiving, by a receiver of a mobile device, transaction information for a financial transaction to be initiated, wherein the transaction information includes at least a transaction amount; storing, in a database, at least one deal and a payment card, wherein each deal of the at least one deal includes at least a discount amount; receiving, via an input of the mobile device, an indication of a deal of the at least one deal to be applied to the financial transaction to be initiated; and initiating, by a processor of the mobile device, a financial transaction using the payment card by transmitting, via the transmitter, an authorization request for the financial transaction, wherein the authorization request includes the payment card and is for a remaining amount, and wherein the remaining amount is based on the transaction amount and the discount amount corresponding to the indicated deal.

A method for initiating a financial transaction includes: identifying, by a processing device, a transaction amount for a financial transaction to be initiated; receiving, from a receiving device, a wallet identifier associated with a mobile device; transmitting, to a server, at least the transaction amount and the wallet identifier; receiving, from the server, deal information corresponding to a deal to be applied to the financial transaction to be initiated, wherein the deal information includes at least a discount amount; initiating, by a processing device, a financial transaction by transmitting, via a transmitting device, an authorization request for the financial transaction, wherein the authorization request is for a remaining amount, and wherein the remaining amount is based on the transaction amount and the discount amount corresponding to the deal.

A mobile device for initiating a financial transaction includes a transmitting device, a receiving device, a database, an input device, and a processor. The transmitting device is configured to transmit a wallet identifier associated with the mobile device. The receiving device is configured to receive transaction information for a financial transaction to be initiated, wherein the transaction information includes at least a transaction amount. The database is configured to store at least one deal and a payment card, wherein each deal of the at least one deal includes at least a discount amount. The input device is configured to read an indication of a deal of the at least one deal to be applied to the financial transaction to be initiated. The processor is configured to initiate a financial transaction using the payment card by transmitting, via the transmitter, an authorization request for the financial transaction, wherein the authorization request includes the payment card and is for a remaining amount, and wherein the remaining amount is based on the transaction amount and the discount amount corresponding to the indicated deal.

A system for initiating a financial transaction includes a processing device, a receiving device, and a transmitting device. The processing device is configured to identify a transaction amount for a financial transaction to be initiated. The receiving device is configured to receive a wallet identifier associated with a mobile device. The transmitting device is configured to transmit, to a server, at least the transaction amount and the wallet identifier. The receiving device is further configured to receive, from the server, deal information corresponding to a deal to be applied to the financial transaction to be initiated, wherein the deal information includes at least a discount amount. The processing device is further configured to initiate a financial transaction by causing the transmitting device to transmit an authorization request for the financial transaction, and wherein the authorization request is for a remaining amount, and the remaining amount is based on the transaction amount and the discount amount corresponding to the deal.

### BRIEF DESCRIPTION OF THE DRAWING FIGURES

Exemplary embodiments are best understood from the following detailed description when read in conjunction with the accompanying drawings. Included in the drawings are the following figures:

FIG. 1 is a block diagram illustrating a system for redeeming a deal and initiating a financial transaction with an electronic wallet in accordance with exemplary embodiments.

FIG. 2 is a block diagram illustrating a mobile device in accordance with exemplary embodiments.

FIG. 3 is a block diagram illustrating the merchant of FIG. 1 in accordance with exemplary embodiments.

FIGS. 4A and 4B are diagrams illustrating a graphical user interface for applying a deal and initiating a financial transaction using an electronic wallet in accordance with exemplary embodiments.

FIGS. 5A and 5B are diagrams illustrating graphical user interfaces for transmitting wallet identifiers to a merchant receiving device in accordance with exemplary embodiments.

FIGS. 6A and 6B are flow diagrams illustrating a method for initiating a financial transaction using an electronic wallet of a mobile device in accordance with exemplary embodiments.

FIGS. 7A and 7B are flow diagrams illustrating a method for initiating a financial transaction using an electronic wallet via a merchant point-of-sale in accordance with exemplary embodiments.

FIG. 8 is a block diagram illustrating system architecture of a computer system in accordance with exemplary embodiments.

FIGS. 9 and 10 are flow charts illustrating exemplary methods for initiating a financial transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Electronic Wallet

An electronic wallet may be a mobile application capable of being stored on and/or executed on a mobile device, such as a smart phone. The electronic wallet may be stored in a memory device located in the mobile device. An electronic wallet may allow a user of the mobile device to enable payment of a financial transaction across multiple channels of commerce by utilizing the electronic wallet application on the mobile device.

The electronic wallet may utilize existing payment networks (e.g., operated by MasterCard, VISA, etc.) which are already accepted by merchants, thereby eliminating the need for heavy integration, while providing more security and better economics. Electronic wallets may function with existing authorization techniques (e.g., personal identification numbers, etc.) and not require modification of existing systems. Additional information regarding methods for implementing and using electronic wallets on a mobile device, including the storage and transmission of payment details for financial transactions, can be found in U.S. patent application Ser. No. 13/209,312, filed Aug. 12, 2011, entitled “Mutli-Commerce Channel Wallet for Authenticated Transactions”; U.S. Provisional Patent Application No. 61/605,588, filed Mar. 1, 2012, entitled “Method and Apparatus for Conducting Mobile Payment Transactions”; and U.S. Provisional Patent Application No. 61/619,095, filed Apr. 2, 2012, entitled “System and Method for Processing Mobile Payments for Mobile Devices Without Secure Elements,” each of which are herein incorporated by reference in their entirety.

### System for Redeeming a Deal Using an Electronic Wallet

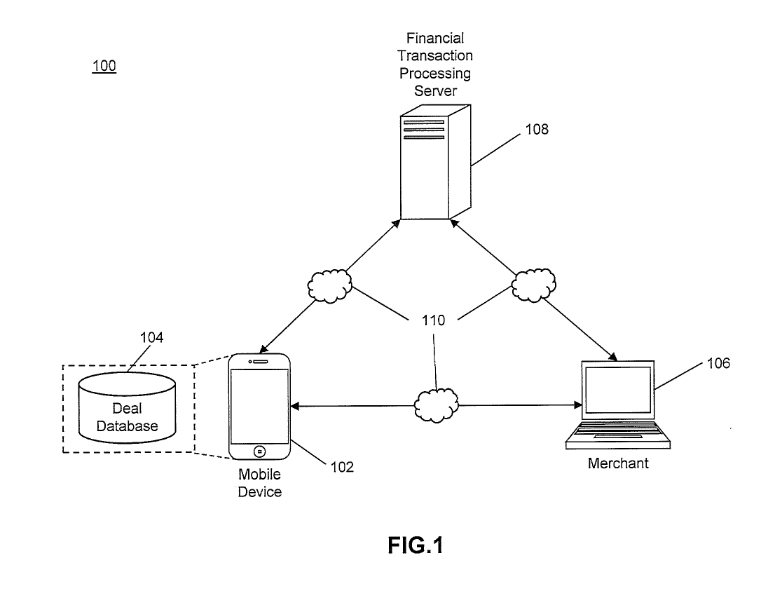

FIG. 1 illustrates a system 100 for applying a deal using an electronic wallet of a mobile device and initiating a financial transaction using the electronic wallet, or, alternatively, a merchant point of sale. The system 100 may include a mobile device 102. The mobile device 102 may be any type of mobile device suitable for performing the functions as disclosed herein, such as a smart phone, as will be apparent to persons having skill in the relevant art. In an exemplary embodiment, the mobile device 102 may include an electronic wallet application.

The mobile device 102 may include a deal database 104. The deal database 104 may be configured to store at least one deal. A deal may be a promotional value that may be applied to a financial transaction with a merchant, such as a discount, a coupon, an offer, etc. A deal may be a discount for a specific product (e.g., $1 off the product) or a stored value for a pre-purchased deal (e.g., user pays $20 to receive $40 worth of goods or services), a discount for a transaction ($10 off any purchase), may be tied to a specific merchant, may require a minimum purchase, etc. Types of deals and offers that may be used in the systems and methods as disclosed herein will be apparent to persons having skill in the relevant art.

Each deal in the deal database 104 may include at least a discount amount. In some embodiments, each deal may also include a deal identifier (e.g., for tracking redemption of the deal). The deal database 104 may be included as part of the electronic wallet, may be included as part of the mobile device 102 but not as part of the electronic wallet, or may be external to the mobile device 102 and accessed via a network (e.g., a network 110, discussed in more detail below). For example, the deal database 104 may be included as part of a financial transaction processing agency. The deal database 104 may be a single database or may include multiple databases interfaced together (e.g., physically, or via a network, such as the network 110). Suitable types and configurations of the deal database 104 will be apparent to persons having skill in the relevant art.

A user of the mobile device 102 may visit a location (e.g., physical, virtual, etc.) of a merchant 106 to conduct a financial transaction. The merchant 106 may ring up products (e.g., goods or services) for purchase by a user of the mobile device 102. The user may indicate that they wish to apply a deal to the transaction. The user or the mobile device 102 may provide a wallet identifier to the merchant 106, which may be entered by the merchant 106 into the transaction (e.g., using the point-of-sale device). In some embodiments, the merchant 106 may obtain the wallet identifier by transmission of the wallet identifier by the mobile device 102 to a point-of-sale or other device of the merchant 106. For example, the mobile device 102 may transmit the wallet identifier to the merchant 106 via near field communication, the mobile device 102 may display a machine-readable code (e.g., a QR code) encoded with the wallet identifier to be read by the merchant 106, etc. Methods of transmitting the wallet identifier to the merchant 106 will be apparent to persons having skill in the relevant art. In some embodiments, the merchant 106 may receive the wallet identifier by reading magnetic media encoded with the wallet identifier, such as the magnetic strip on a payment card (e.g., for which the user of the mobile device 102 is the cardholder). It will be apparent to persons having skill in the relevant art that reading information (e.g., the wallet identifier) encoded in a payment card may be performed without using a financial transaction processing network and may be done using existing point-of-sale systems.

The wallet identifier may be a unique value associated with the mobile device 102, such as a unique number (e.g., a Media Access Control number, phone number, etc.), an e-mail address, a name, or any other value that may be uniquely associated with the mobile device 102. The merchant 106 may transmit purchase details for the potential transaction to a financial transaction processing server 108. The purchase details may include at least the amount of the transaction, the wallet identifier, and a merchant identifier associated with the merchant 106.

In one embodiment, the financial transaction processing server 108 may, using the wallet identifier, push at least the amount of the transaction to the mobile device 102. The mobile device 102 may display (e.g., via the electronic wallet application) the transaction to the user and the user may indicate a deal from the deal database 104 to be applied to the transaction. In one embodiment, the electronic wallet may automatically display only those deals that would be valid for the present transaction (e.g., based on the merchant 106, the transaction amount, etc.). In a further embodiment, the information transmitting by the financial transaction processing server 108 may include information indicating only those deals that may be valid for the present transaction. Once a deal has been indicated, the electronic wallet may apply the deal to the transaction (e.g., and reducing the transaction amount based on the discount amount corresponding to the deal) and may prompt the user to select a payment card. The user may select a payment card and the mobile device 102 may initiate a financial transaction for the reduced transaction amount using the selected payment card by submitting an authorization request to the financial transaction processing server 108.

In an alternative embodiment, the financial transaction processing server 108 may, using the wallet identifier, transmit deal information corresponding to a deal to be applied to the transaction to the merchant 106. The deal information may include at least a discount amount (e.g., $10, 10%, etc.) for the corresponding deal. The merchant 106 may calculate a remaining amount for the transaction by applying the discount amount to the transaction amount, and may initiate a financial transaction for the remaining amount by submitting an authorization request to the financial transaction processing server 108. It will be apparent to persons having skill in the relevant art that, in this embodiment, the merchant 106 may obtain payment information from the electronic wallet of the mobile device 102 at multiple steps in the process. For example, the merchant 106 may obtain payment details prior to obtaining the wallet identifier, at the same time as obtaining the wallet identifier (e.g., using near field communication), or after applying the deal to the transaction but prior to submitting the authorization request. Methods for transmitting and/or receiving payment details using an electronic wallet will be apparent to persons having skill in the relevant art.

The financial transaction processing server 108 may receive the authorization request and may, using methods apparent to those having skill in the relevant art, process the financial transaction for the reduced amount and using the selected payment card. For example, the financial transaction processing server 108 may process the financial transaction using a traditional four party system (e.g., consumer, merchant, acquirer, and issuer). The financial transaction processing server 108 may notify the merchant 106 (e.g., and the mobile device 102) of a response to the authorization request. The merchant 106 may then finalize the transaction (e.g., by providing the goods and/or services to the user of the mobile device 102).

Each of the mobile device 102, the merchant 106, and the financial transaction processing server 108 may be configured to communicate via the network 110. The network 110 may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

### Exemplary Mobile Device

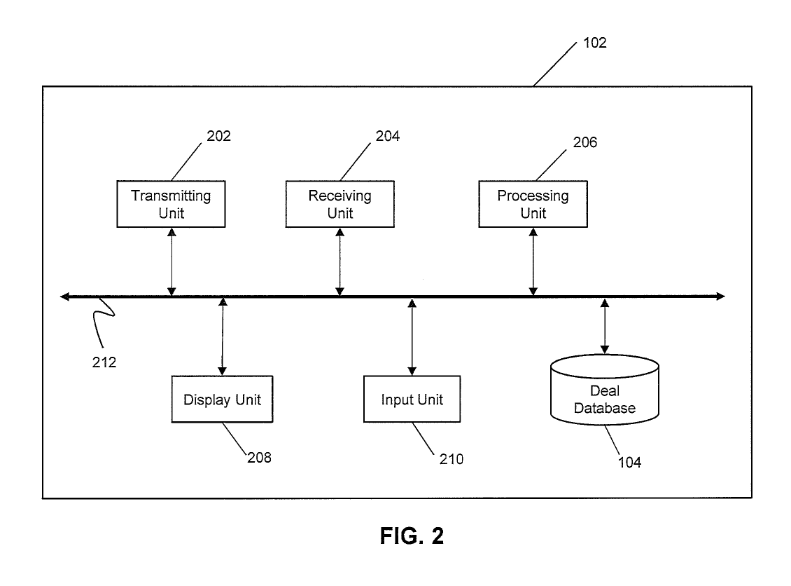

FIG. 2 illustrates a block diagram of the mobile device 102. The mobile device 102 may include the deal database 104, a transmitting unit 202, a receiving unit 204, a processing unit 206, a display unit 208, and an input unit 210. Each of the components may be connected via a bus 212. Suitable types and configurations of the bus 212 will be apparent to persons having skill in the relevant art.

The transmitting unit 202 may be configured to transmit the wallet identifier associated with the mobile device 102 (e.g., to the financial transaction processing server 108 and/or the merchant 106). In one embodiment, the transmitting unit 202 may be configured to transmit the wallet identifier via near field communication. The receiving unit 204 may be configured to receive (e.g., from the financial transaction processing server 108) purchase details for a transaction. The purchase details may include at least the transaction amount, but may also include the merchant identifier, product information, etc.

The display unit 208 may be configured to display the received purchase details and at least one deal included in the deal database 104 to the user. The display unit 208 may be any type of display suitable for display information to a user of the mobile device, such as a liquid crystal display (LCD), a light-emitting diode (LED) display, a capacitive touch display, etc. In one embodiment, the processing unit 206 may be configured to identify only deals in the deal database 104 that are valid for application for the purchase. In another embodiment, the purchase details may include deals valid for application for the purchase (e.g., as identified by the financial transaction processing server 108). In one embodiment, the display unit 208 may be configured to display a machine readable code (e.g., a bar code, such as a QR code) encoded with the wallet identifier (e.g., to transmit the wallet identifier to the merchant 106).

The input unit 210 may be configured to receive input from a user indicating a deal to be applied to the transaction. The input unit 210 may be any input device suitable for performing the functions as disclosed herein, such as a keyboard, a capacitive touch display, etc. The processing unit 206 may identify the discount amount corresponding to the indicated deal, and may identify a reduced amount based on the transaction amount and the discount amount. The display unit 208 may be configured to display the reduced amount to the user of the mobile device 102. The input unit 210 may be further configured to receive input from a user indicating a payment card to be used for the transaction.

Once a payment card has been indicated, the processing unit 206 may be configured to cause the transmitting unit 202 to transmit an authorization request for a financial transaction (e.g., to the financial transaction processing server 108). The authorization request may include the payment card and may be for the reduced amount.

### Exemplary Merchant Point of Sale

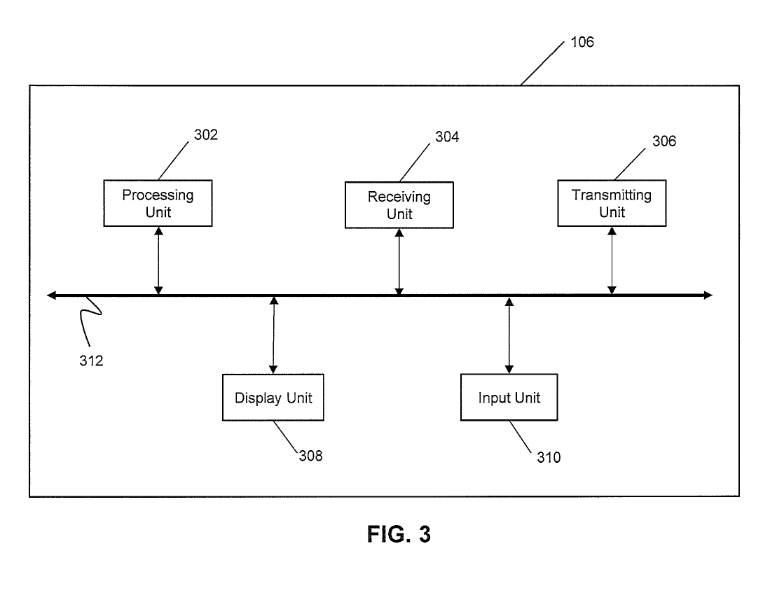

FIG. 3 illustrates a block diagram of the merchant 106. The merchant 106 may include a processing unit 302, a receiving unit 304, a transmitting unit 306, a display unit 308, and an input unit 310. Each of the components may be connected via a bus 312. Suitable types and configurations of the bus 312 will be apparent to persons having skill in the relevant art.

The processing unit 302 may be configured to identify a transaction amount for a financial transaction to be initiated (e.g., such as through ringing up items at the merchant 106 point-of-sale). The receiving unit 304 may be configured to receive a wallet identifier associated with a mobile device (e.g., the mobile device 102). The receiving unit 304 may receive the wallet identifier using near field communication, by reading a machine readable code (e.g., a QR code) or magnetic media encoded with the wallet identifier, etc. The transmitting unit 306 may be configured to transmit the identified transaction amount and received wallet identifier to a server (e.g., the financial transaction processing server 108).

The receiving unit 304 may be further configured to receive (e.g., from the financial transaction processing server 108), deal information corresponding to a deal to be applied to the financial transaction to be initiated. The deal information may include at least a discount amount for the corresponding deal. The processing unit 302 may be configured to apply the discount amount to the transaction amount to obtain a remaining amount for the financial transaction to be initiated. The processing unit 302 may then initiate a financial transaction by causing the transmitting unit 306 to transmit an authorization request for the financial transaction to the financial transaction processing server 108.

### Graphical User Interfaces

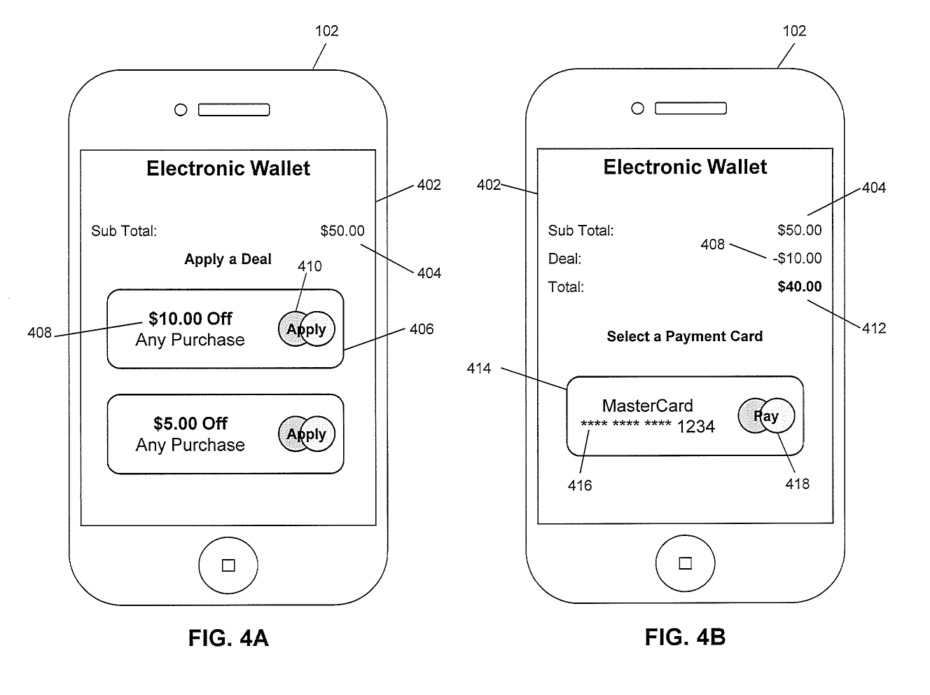

FIGS. 4A and 4B illustrate a graphical user interface of the mobile device 102 for the indication of a deal and a payment card for initiating a financial transaction.

As illustrated in FIG. 4A, a display 402 of the mobile device 102 may display the electronic wallet application. The application may display a transaction amount 404, which may be received from the financial transaction processing server 108. The application may also display at least one deal 406 that may be applied to the transaction. Each deal displayed may also include a discount amount 408 and a button 410. The user may interact with the button 410 (e.g., via the input unit 210) to indicate the corresponding deal 406 to be applied to the transaction. The processing unit 206 may then apply the deal 406 to the transaction as discussed herein.

Once the deal has been applied, the display 402 may display a graphical user interface as illustrated in FIG. 4B. The display 402 may display to the user of the mobile device 102 the transaction amount 404, the discount amount 408 of the indicated deal 406, and a reduced amount 412. The electronic wallet application may also display at least one payment card 414 for use in paying for the transaction. The display of the payment card 414 may include a card identifier 416. The card identifier 416 may include a commercial name for the card, the issuer of the payment card, the payment card number (e.g., which may be partially obscured as illustrated in FIG. 4B), or a customized name or display as selected by the user of the mobile device 102.

The payment card 414 may also include a button 418. The user may interact with the button 418 to indicate the payment card 414 for payment. The mobile device 102 may then initiate a financial transaction by transmitting an authorization request to the financial transaction processing server 108. The authorization request may include at least the reduced amount 412 and the payment card 414 to be charged in the transaction. In some embodiments, the display 402 may display a confirmation message to the user once the authorization request has been transmitted and/or a confirmation message may be transmitted to the mobile device 102 (e.g., via electronic mail, short message service, etc.).

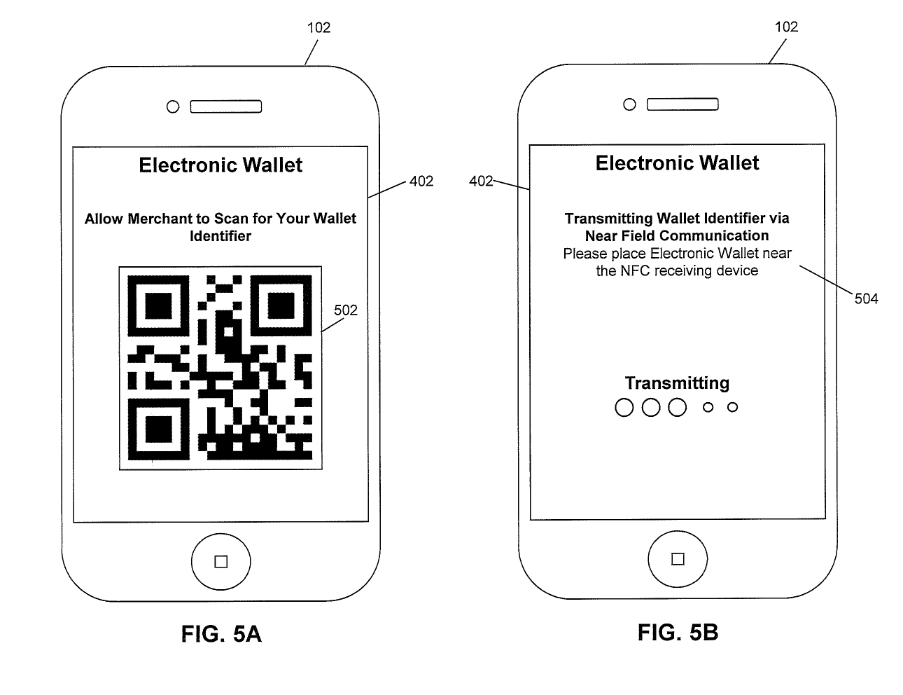

FIGS. 5A and 5B illustrate graphical user interfaces for the mobile device 102 for the transmitting of the wallet identifier to the merchant 106 (e.g., for initiation of the financial transaction by the merchant 106 point-of-sale).

In embodiments where the mobile device 102 may transmit the wallet identifier using machine readable code, the display 402 of the mobile device 102 may display a machine readable code 502. The machine readable code 502 may be encoded with at least the wallet identifier. The machine readable code 502 may be a bar code or any other type of machine readable code suitable for the transmission of the wallet identifier to the merchant 106, such as a QR code as illustrated in FIG. 5A.

In embodiments where the mobile device 102 may transmit the wallet identifier using near field communication, the display 402 of the mobile device 102 may display a notification message 504. The notification message 504 may indicate to the user of the mobile device 102 that the mobile device 102 is currently transmitting (e.g., via the transmitting unit 202) the wallet identifier via near field communication. In some embodiments, the display 402 may also display payment card information for the user to indicate a payment card to be transmitted to the merchant 106 in addition to the wallet identifier. For example, the display 402 may display the payment card 414 as illustrated in FIG. 4B. In one embodiment, the user of the mobile device 102 may select the payment card 414 using the wallet application prior to the transmission of information via near field communication, such as indicated in the notification message 504 of FIG. 5B.

### Method for Redeeming a Deal and Initiating a Financial Transaction Using an Electronic Wallet

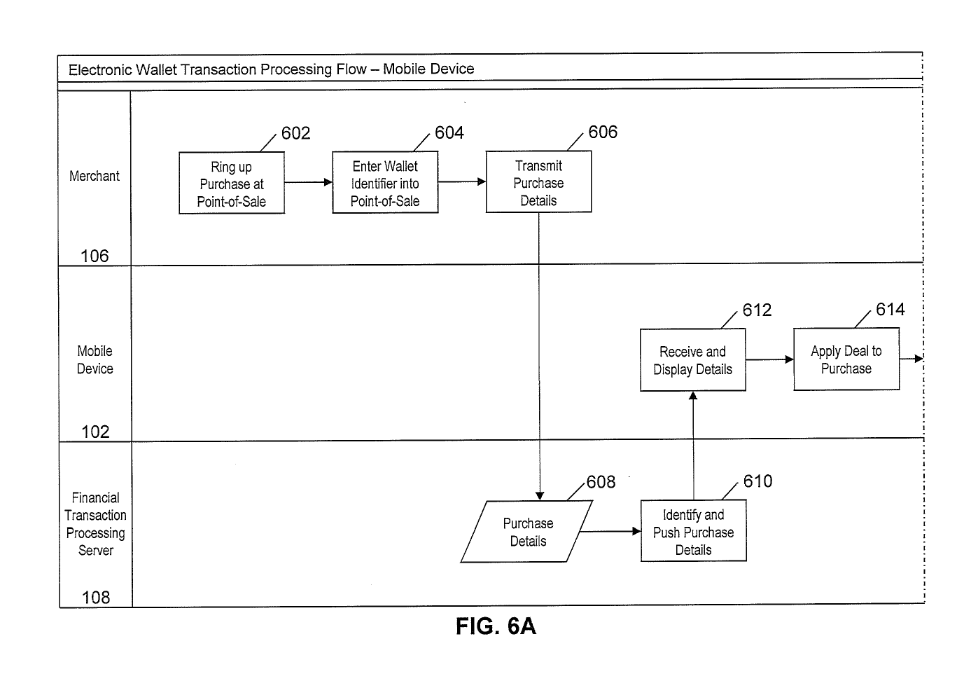

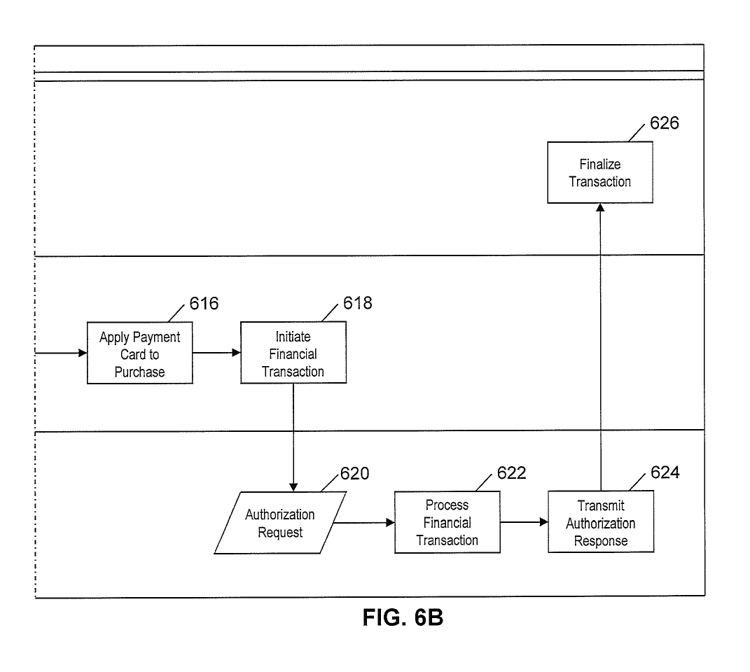

FIGS. 6A and 6B are a flow diagram illustrating a method for redeeming a deal using an electronic wallet and initiating a financial transaction.

In step 602, the merchant 106 may ring up a purchase for a user of the mobile device 102 at the point-of-sale. In step 604, the merchant 106 may enter the wallet identifier associated with the mobile device 102 into the point-of-sale. In one embodiment, the merchant 106 may manually enter the wallet identifier. In another embodiment, the merchant 106 may use a reader device to read a machine-readable code displayed by the mobile device 102 encoded with the wallet identifier. In a further embodiment, the machine-readable code may be a QR code. In one embodiment, the mobile device 102 may transmit the wallet identifier to the merchant 106 point-of-sale using near field communication.

In step 606, the merchant 106 may transmit purchase details to the financial transaction processing server 108, who may receive the purchase details in step 608. The purchase details may include at least the transaction amount, the wallet identifier, and a merchant identifier associated with the merchant 106. In step 610, the financial transaction processing server 108 may identify the mobile device 102 based on the wallet identifier and may push (e.g., transmit) the purchase details to the mobile device 102. In step 612, the mobile device 102 may receive (e.g., via the receiving unit 204) the purchase details and may display them (e.g., via the display unit 208) to the user. In one embodiment, the mobile device 102 may also receive from the financial transaction processing server 108 information identifying deals (e.g., stored in the deal database 104) that are valid for applying to the financial transaction to be initiated. In a further embodiment, the mobile device 102 may display only those deals identified as being valid for the financial transaction.

In step 614, the mobile device 102 may receive an indication (e.g., via the input unit 210) of a deal (e.g., stored in the deal database 104) to be applied to the purchase and may apply the deal. Application of the deal to the purchase may include identifying (e.g., calculating) a reduced transaction amount based on the transaction amount and a discount amount corresponding to the indicated deal. In step 616, the mobile device 102 may receive an indication of a payment card to be applied to the purchase. Using the indicated payment card, the mobile device 102 may then, in step 618, initiate a financial transaction by transmitting an authorization request. The authorization request may include at least the reduced transaction amount and the payment card.

In step 620, the financial transaction processing server 108 may receive the authorization request for the initiated financial transaction. In step 622, the financial transaction processing server 108 may process the financial transaction. Methods for processing a financial transaction will be apparent to persons having skill in the relevant art. In step 624, the financial transaction processing server 108 may transmit an authorization response (e.g., indicating approval or denial of the transaction) to the merchant 106. The merchant 106 may receive the authorization response and, in step 626, may finalize the transaction accordingly. In some embodiments, the financial transaction processing server 108 may also transmit a notification of the processing of the financial transaction to the mobile device 102 (e.g., for display via the display unit 208).

### Method for Redeeming a Deal and Initiating a Financial Transaction at the Merchant Point-of-Sale

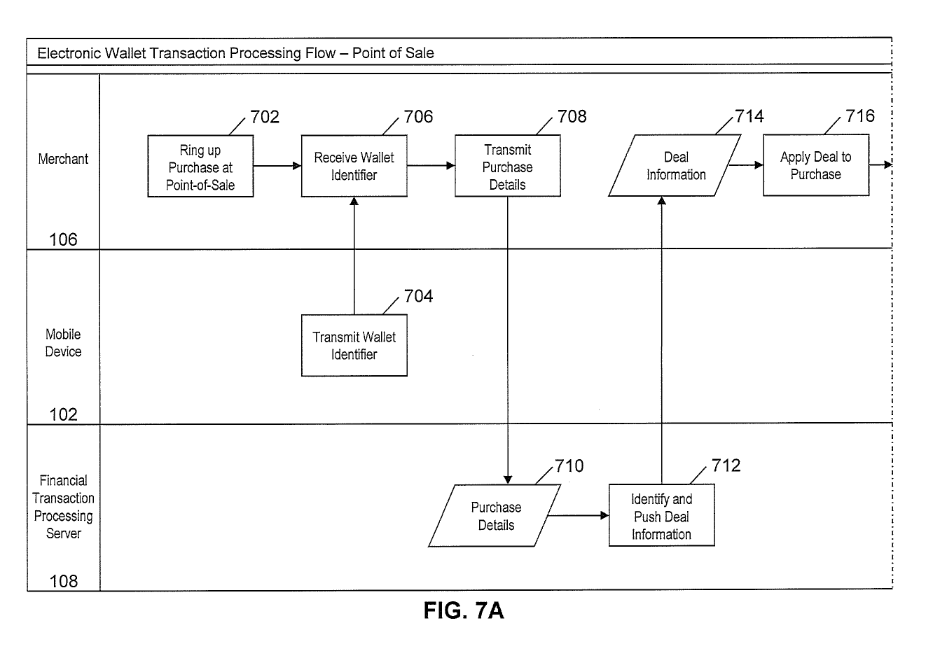

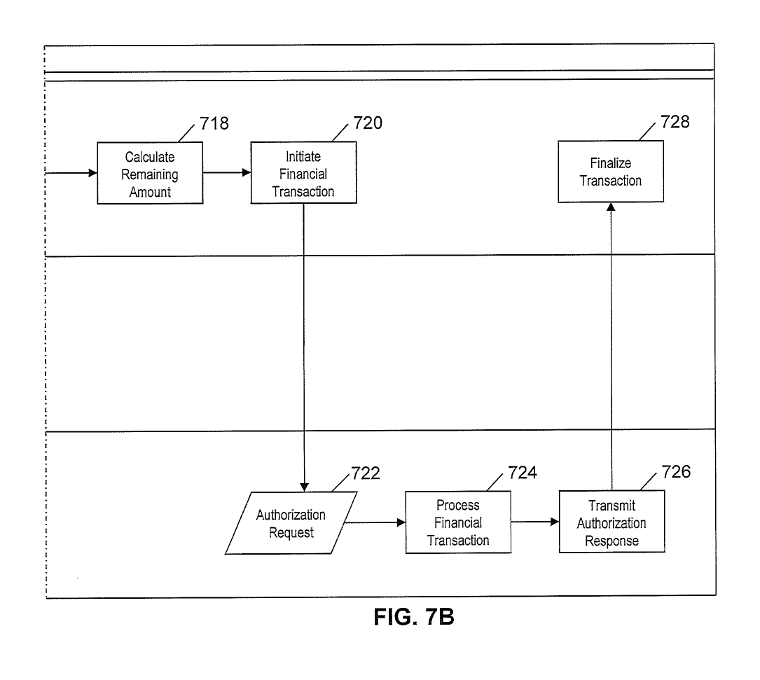

FIGS. 7A and 7B are a flow diagram illustrating a method for redeeming a deal of an electronic wallet of a mobile device and initiating a financial transaction via a merchant point-of-sale.

In step 702, the merchant 106 may ring up a purchase for a user of the mobile device 102 at the point-of-sale and identify a transaction amount for the purchase. In some embodiments, the merchant 106 may obtain payment details regarding payment for the financial transaction during step 702. In step 704, the mobile device 102 may transmit the wallet identifier to the merchant 106. In one embodiment, the mobile device 102 may transmit the wallet identifier using near field communication. In another embodiment, the wallet identifier may be transmitted by display a machine readable code encoded with the wallet identifier on the mobile device 102. In a further embodiment, the machine readable code may be a bar code. In one embodiment, the bar code may be a QR code. In some embodiments, the mobile device 102 may also transmit payment details in addition to the wallet identifier.

In step 706, the merchant 106 may receive the wallet identifier. Then, in step 708, the merchant 106 may transmit purchase details to the financial transaction processing server 108. The purchase details may include at least the identified transaction amount and the received wallet identifier. The financial transaction processing server 108 may receive the purchase details in step 710, and then, in step 712, may identify a deal to be applied to the transaction and push corresponding deal information to the merchant 106. The deal information may include at least a discount amount of the corresponding deal. In one embodiment the discount amount may be an integer (e.g., $10 off) or a percent (e.g., 10% off).

In step 714, the merchant 106 may receive the deal information, and then may apply the deal to the purchase in step 716. As part of applying the deal to the purchase, the merchant 106 may calculate, in step 718, a remaining amount for the purchase. In one embodiment, the remaining amount may be calculated by reducing the transaction amount based on the discount amount of the corresponding deal. In step 720, the merchant 106 may initiate a financial transaction by submitting an authorization request to the financial transaction processing server 108 for the remaining transaction amount.

In step 722, the financial transaction processing server 108 may receive the authorization request for the initiated financial transaction. In step 724, the financial transaction processing server 108 may process the financial transaction. Methods for processing a financial transaction will be apparent to persons having skill in the relevant art. In step 726, the financial transaction processing server 108 may transmit an authorization response (e.g., indicating approval or denial of the transaction) to the merchant 106. The merchant 106 may receive the authorization response and, in step 728, may finalize the transaction accordingly. In some embodiments, the financial transaction processing server 108 may also transmit a notification of the processing of the financial transaction to the mobile device 102 (e.g., for display via the display unit 208).

### Computer System Architecture

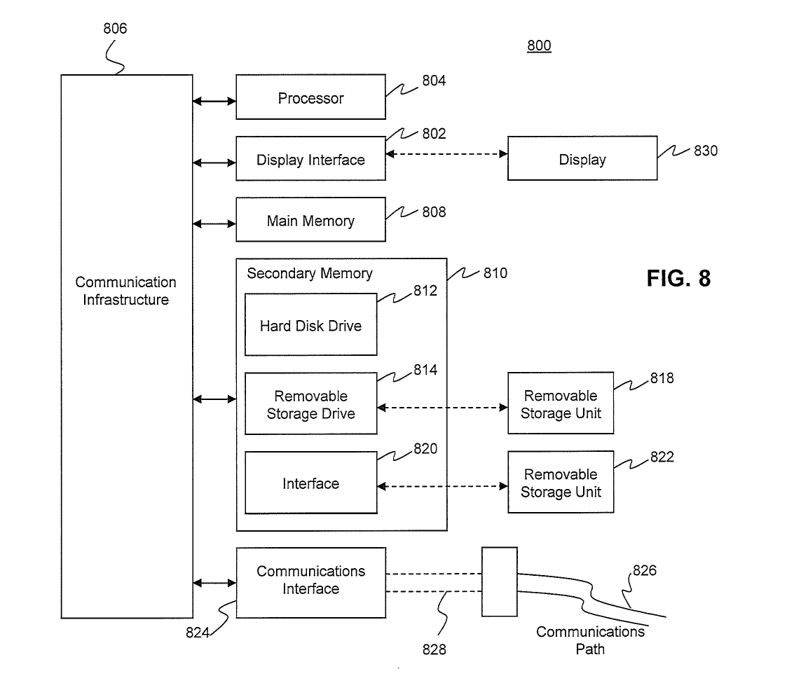

FIG. 8 illustrates a computer system 800 in which embodiments of the present disclosure, or portions thereof, may be implemented as computer-readable code. For example, the deal provider 104, the merchant 106, and the financial transaction processing agency 110 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 6A, 6B, 7A, 7B, 9, and 10.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communication infrastructure 806, such as a bus, message queue, network (e.g., the network 110), multi-core message-passing scheme, etc. The computer system 800 may also include a main memory 508 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage unit 818 in a well-known manner. The removable storage unit 818 may include a removable storage media that may be read by and written to by the removable storage drive 814. For example, if the removable storage drive 814 is a floppy disk drive, the removable storage unit 818 may be a floppy disk. In one embodiment, the removable storage unit 818 may be non-transitory computer readable recording media.

In some embodiments, the secondary memory 810 may include alternative means for allowing computer programs or other instructions to be loaded into the computer system 800, for example, the removable storage unit 822 and an interface 820. Examples of such means may include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

Computer program medium and computer usable medium may refer to memories, such as the main memory 808 and secondary memory 810, which may be memory semiconductors (e.g. DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 6A, 6B, 7A, 7B, 9, and 10, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

### A First Exemplary Method for Initiating a Financial Transaction

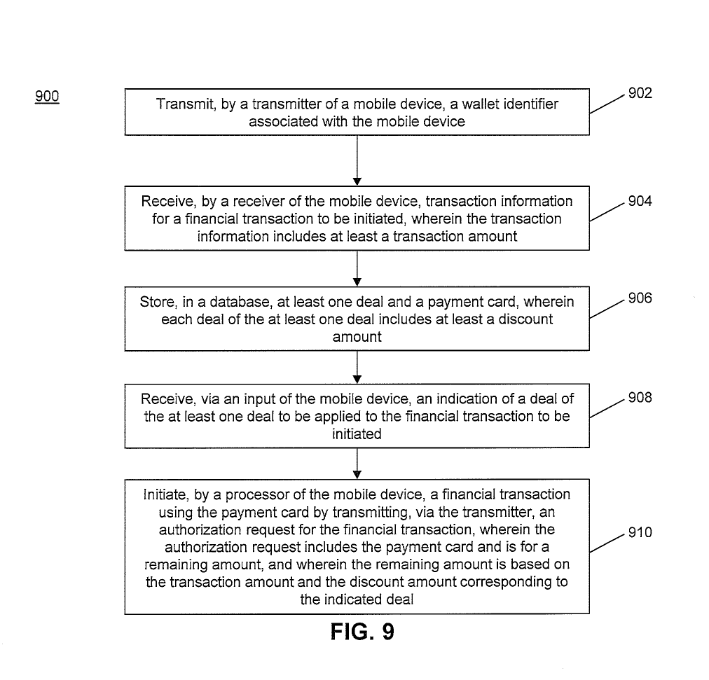

FIG. 9 illustrates a method 900 for initiating a financial transaction using a mobile device (e.g., the mobile device 102).

In step 902, a transmitter of the mobile device 102 (e.g., the transmitting unit 202) may transmit a wallet identifier associated with the mobile device 102. In one embodiment, the wallet identifier may be a unique value. In a further embodiment, the wallet identifier may be at least one of a media access control address, a serial number, an e-mail address, and a phone number. In one embodiment, transmitting the wallet identifier may include transmitting the wallet identifier using near field communication. In another embodiment, transmitting the wallet identifier may include display (e.g., via the display unit 208) a machine readable code encoded with the wallet identifier. In a further embodiment, the machine readable code may be a bar code. In an even further embodiment, the bar code may be a QR code.

In step 904, a receiver of the mobile device 102 (e.g., the receiving unit 204) may receive transaction information for a financial transaction to be initiated, wherein the transaction information includes at least a transaction amount (e.g., the transaction amount 404). In one embodiment, the transaction information may further include an identification of deals that are be valid for the financial transaction to be initiated.

In step 906, at least one deal and a payment card (e.g., the payment card 414) may be stored in a database (e.g., the deal database 104), wherein each deal of the at least one deal includes at least a discount amount (e.g., the discount amount 408). In one embodiment the discount amount may be a number. In a further embodiment, the discount amount may be an integer or a percentage. In step 908, an indication of a deal (e.g., the deal 406) of the at least one deal to be applied to the financial transaction to be initiated may be received via an input (e.g., the input unit 210) of the mobile device 102. In one embodiment the input may be a capacitive touch screen display. In one embodiment, the indicated deal may be one of the deals identified as valid for the financial transaction to be initiated.

In step 901, a processor (e.g., the processing unit 206) of the mobile device 102 may initiate a financial transaction by transmitting, via the transmitting unit 202, an authorization request using the payment card 414 for the financial transaction, wherein the authorization request includes the payment card 414 and is for a remaining amount (e.g., the remaining amount 412), and wherein the remaining amount 402 is based on the transaction amount 404 and the discount amount 408 corresponding to the indicated deal 406.

### A Second Exemplary Method for Initiating a Financial Transaction

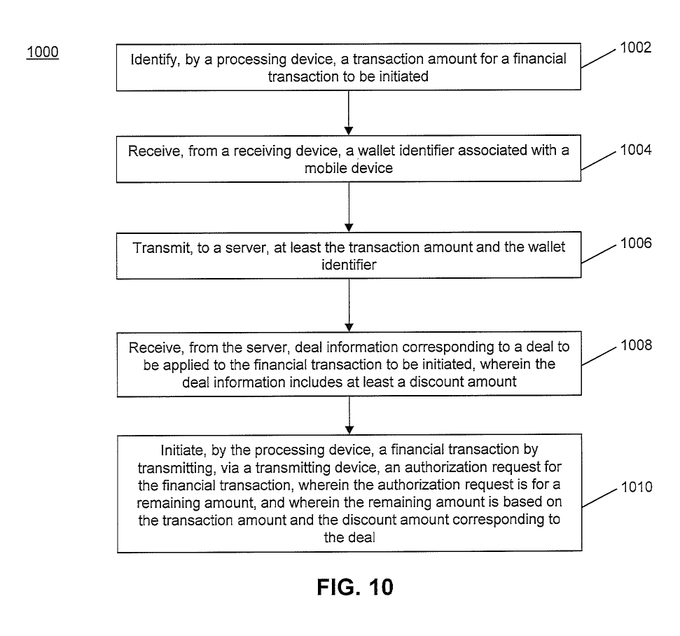

FIG. 10 illustrates a method 1000 for initiating a financial transaction using a merchant point-of-sale (e.g., the merchant 106).

In step 1002, a transaction amount for a financial transaction to be initiated may be identified by a processing device (e.g., the processing unit 302). In step 1004, a wallet identifier associated with a mobile device (e.g., the mobile device 102) may be received from a receiving device (e.g., the receiving unit 304). In one embodiment, the wallet identifier may be at least one of a media control access address, a serial number, an e-mail address, and a phone number. In one embodiment, receiving the wallet identifier may include receiving the wallet identifier using near field communication. In another embodiment, receiving the wallet identifier may include reading, by a reading device, a machine readable code (e.g., the machine readable code 502) encoded with the wallet identifier and displayed by the mobile device 102. In a further embodiment, the machine readable code may be a bar code. In an even further embodiment, the bar code may be a QR code. In yet another embodiment, receiving the wallet identifier may include reading, by a reading device, a magnetic media encoded with the wallet identifier. In a further embodiment, the magnetic media may be a payment card.

In step 1006, at least the wallet identifier and the transaction amount may be transmitted (e.g., via the transmitting unit 306) to a server (e.g., the financial transaction processing server 108). In step 1008, deal information corresponding to a deal to be applied to the financial transaction to be initiated may be received (e.g., by the receiving unit 304) from the financial transaction processing server 108, wherein the deal information includes at least a discount amount. In one embodiment the discount amount may be a number. In a further embodiment the discount amount may be an integer or a percentage.

In step 1010, a financial transaction may be initiated by the processing unit 302 by transmitting, via the transmitting unit 306, an authorization request for the financial transaction, wherein the authorization request is for a remaining amount and wherein the remaining amount is based on the transaction amount and the discount amount corresponding to the deal.

Techniques consistent with the present disclosure provide, among other features, systems and methods for on redeeming deals using an electronic wallet and initiating a financial transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for initiating a financial transaction on a mobile device, comprising:
transmitting, by a transmitter of a mobile device, a wallet identifier associated with the mobile device;
receiving, by a receiver of the mobile device, transaction information for a financial transaction to be initiated, wherein the transaction information includes at least a transaction amount;
storing, in a database, at least one deal and a payment card, wherein each deal of the at least one deal includes at least a discount amount;
receiving, via an input of the mobile device, an indication of a deal of the at least one deal to be applied to the financial transaction to be initiated; and
initiating, by a processor of the mobile device, a financial transaction using the stored payment card by transmitting, via the transmitter, an authorization request for the financial transaction,
wherein the authorization request includes the payment card and is for a remaining amount, and
wherein the remaining amount is based on the transaction amount and the discount amount corresponding to the indicated deal.

2. The method of claim 1, wherein transmitting the wallet identifier includes transmitting the wallet identifier using near field communication.

3. The method of claim 1, wherein transmitting the wallet identifier includes displaying, by a display of the mobile device, a machine readable code encoded with the wallet identifier.

4. The method of claim 3, wherein the machine readable code is a bar code.

5. The method of claim 4, wherein the bar code is a QR code.

6. The method of claim 1, wherein the transaction information further includes an identification of deals of the at least one deal that are valid for the financial transaction to be initiated.

7. The method of claim 6, wherein the indicated deal is one of the identified deals valid for the financial transaction to be initiated.

8. The method of claim 1, wherein the discount amount is an integer or a percentage.

9. The method of claim 1, wherein the wallet identifier is at least one of a media control access address, a serial number, an e-mail address, and a phone number.

10. A method for initiating a financial transaction, comprising:
identifying, by a processing device, a transaction amount for a financial transaction to be initiated;
receiving, from a receiving device, a wallet identifier associated with a mobile device;
transmitting, to a server, at least the transaction amount and the wallet identifier;
receiving, from the server, deal information corresponding to a deal to be applied to the financial transaction to be initiated, wherein the deal information includes at least a discount amount;
initiating, by a processing device, a financial transaction by transmitting, via a transmitting device, an authorization request for the financial transaction,
wherein the authorization request is for a remaining amount, and
wherein the remaining amount is based on the transaction amount and the discount amount corresponding to the deal.

11. The method of claim 10, wherein receiving the wallet identifier includes receiving the wallet identifier using near field communication.

12. The method of claim 10, wherein receiving the wallet identifier includes reading, by a reading device, a machine readable code encoded with the wallet identifier and displayed by the mobile device.

13. The method of claim 12, wherein the machine readable code is a bar code.

14. The method of claim 13, wherein the bar code is a QR code.

15. The method of claim 10, wherein the received wallet identifier is transmitted by the mobile device.

16. The method of claim 10, wherein receiving the wallet identifier includes reading, by a reading device, a magnetic media encoded with the wallet identifier.

17. The method of claim 16, wherein the magnetic media is a payment card.

18. The method of claim 10, wherein the discount amount is an integer or a percentage.

19. The method of claim 10, wherein the wallet identifier is at least one of a media control access address, a serial number, an e-mail address, and a phone number.

20. A mobile device for initiating a financial transaction, comprising:
a transmitting device configured to transmit a wallet identifier associated with the mobile device;
a receiving device configured to receive transaction information for a financial transaction to be initiated, wherein the transaction information includes at least a transaction amount;
a database configured to store at least one deal and a payment card, wherein each deal of the at least one deal includes at least a discount amount;
an input device configured to read an indication of a deal of the at least one deal to be applied to the financial transaction to be initiated; and
a processing device configured to initiate a financial transaction using the payment card by causing the transmitting device to transmit an authorization request for the financial transaction,
wherein the authorization request includes the payment card and is for a remaining amount, and
wherein the remaining amount is based on the transaction amount and the discount amount corresponding to the indicated deal.

21. The system of claim 20, wherein the transmitting device is configured to transmit the wallet identifier using near field communication.

22. The system of claim 20, wherein the transmitting device is configured to transmit the wallet identifier by causing a display of the mobile device to display a machine readable code encoded with the wallet identifier.

23. The system of claim 22, wherein the machine readable code is a bar code.

24. The system of claim 23, wherein the bar code is a QR code.

25. The system of claim 20, wherein the transaction information further includes an identification of deals of the at least one deal that are valid for the financial transaction to be initiated.

26. The system of claim 25, wherein the indicated deal is one of the identified deals valid for the financial transaction to be initiated.

27. The system of claim 20, wherein the discount amount is an integer or a percentage.

28. The system of claim 20, wherein the wallet identifier is at least one of a media control access address, a serial number, an e-mail address, and a phone number.

29. A system for initiating a financial transaction, comprising:
a processing device configured to identify a transaction amount for a financial transaction to be initiated;
a receiving device configured to receive a wallet identifier associated with a mobile device; and
a transmitting device configured to transmit, to a server, at least the transaction amount and the wallet identifier, wherein
the receiving device is further configured to receive, from the server, deal information corresponding to a deal to be applied to the financial transaction to be initiated, wherein the deal information includes at least a discount amount, and
the processing device is further configured to initiate a financial transaction by causing the transmitting device to transmit an authorization request for the financial transaction, and wherein
the authorization request is for a remaining amount, and
the remaining amount is based on the transaction amount and the discount amount corresponding to the deal.

30. The system of claim 29, wherein the receiving device is configured to receive the wallet identifier using near field communication.

31. The system of claim 29, wherein the receiving device is configured to read a machine readable code encoded with the wallet identifier and displayed by the mobile device.

32. The system of claim 31, wherein the machine readable code is a bar code.

33. The system of claim 32, wherein the bar code is a QR code.

34. The system of claim 29, wherein the received wallet identifier is transmitted by the mobile device.

35. The system of claim 29, wherein the receiving device is configured to read a magnetic media encoded with the wallet identifier.

36. The system of claim 35, wherein the magnetic media is a payment card.

37. The system of claim 29, wherein the discount amount is an integer or a percentage.

38. The system of claim 29, wherein the wallet identifier is at least one of a media control access address, a serial number, an e-mail address, and a phone number.
